(19) United States
(12) Patent Application Publication
(10) Pub. No.: US 2015/0336553 A1
(43) Pub. Date: Nov. 26, 2015

(54) Electromagnetic Valve and Brake Device

(71) Applicant: HITACHI AUTOMOTIVES SYSTEMS, LTD., Hitachinaka-shi, Ibaraki (JP)

(72) Inventors: Masayuki SAITO, Sagamihara-shi, Kanagawa (JP); Chiharu NAKAZAWA, Kawasaki-shi, Kanagawa (JP); Masaki MISUNOU, Atsugi-shi, Kanagawa (JP)

(73) Assignee: HITACHI AUTOMOTIVES SYSTEMS, LTD., Hitachinaka-shi, Ibaraki (JP)

(21) Appl. No.: 14/759,844

(22) PCT Filed: Dec. 26, 2013
(86) PCT No.: PCT/JP2013/084873

§ 371 Date: Jul. 8, 2015

(30) Foreign Application Priority Data
Jan. 9, 2013 (JP) 2013-002101

(51) Int. Cl. B60T 13/68; B60T 8/36; F16K 31/06

(52) U.S. Cl. CPC B60T 13/686; F16K 31/0655; B60T 8/363

(57) ABSTRACT

The present invention provides an electromagnetic valve capable of achieving a stable flow rate while suppressing power consumption and a brake device with such an electromagnetic valve. The electromagnetic valve according to the present invention has a valve element axially movable by the action of an electromagnetic force generated upon energization of a coil, a first elastic member that biases the valve element in a valve opening direction, and a second elastic member that biases in a direction that counteracts the biasing of the first elastic member, wherein the first elastic member is set with a set load larger than that of the second elastic member.

### FIELD OF THE INVENTION

The present invention relates to an electromagnetic valve for controlling a flow rate by the action of an electromagnetic force generated upon energization of a coil and to a brake device with such an electromagnetic valve.

### BACKGROUND ART

An electromagnetic valve is known capable of controlling a flow rate by adjusting its valve opening amount upon energization of a coil as disclosed in Patent Document 1. In this type of electromagnetic valve, a valve element is biased in a valve opening direction by a coil spring. By the action of an electromagnetic force generated upon energization of the coil, the valve element is attracted in a valve closing direction so as to adjust the valve opening amount and thereby control the flow rate.

### Prior Art Documents

### Patent Document

Patent Document 1: Japanese Examined Patent Publication No. 2011-21670

### SUMMARY OF THE INVENTION

### Problem to be Solved by the Invention

In the case where the valve element is biased by an elastic member relatively low in spring stiffness, such as coil spring, as disclosed in Patent Document 1, there occurs a large change in the position of the valve element with respect to a change in the electromagnetic force so that the electromagnetic valve tends to cause a large error in the valve opening amount, i.e., a large error between the actual flow rate and the target flow rate. If the spring stiffness is increased to reduce this error, it becomes necessary to increase the electromagnetic force so that the electromagnetic valve requires high power consumption.

It is accordingly an object of the present invention to provide an electromagnetic valve capable of achieving a stable flow rate while suppressing power consumption. It is also an object of the present invention to provide a brake device with such an electromagnetic valve.

### Means for Solving the Problem

As a solution to the above problem, the present invention provides an electromagnetic valve comprising a valve element axially movable by the action of an electromagnetic force generated upon energization of a coil; a first elastic member that biases the valve element in a valve opening direction; and a second elastic member that biases in a direction that counteracts the biasing of the first elastic member, wherein the first elastic member is set with a set load larger than that of the second elastic member.

### Effects of the Invention

It is possible according to the present invention to reduce an error with respect to the target flow rate while suppressing power consumption.

### BRIEF DESCRIPTION OF DRAWINGS

FIG. 1 is a hydraulic circuit diagram of a brake device according to a first embodiment of the present invention.

FIG. 2 is a section view of a gate-out valve of the brake device as an electromagnetic valve according to the first embodiment of the present invention.

FIG. 3 is a characteristic diagram showing a relationship between control current and flow rate of the electromagnetic valve in view of difference in spring stiffness.

FIG. 4A and 4B are section views showing comparison between the first embodiment of the present invention and comparative example.

FIG. 5 is a characteristic diagram showing a relationship between plunger stroke and spring force of the electromagnetic valve according to the first embodiment of the present invention and according to the comparative example.

FIG. 6 is a section view of a plunger and its vicinity of an electromagnetic valve according to a second embodiment of the present invention.

FIG. 7 is a section view of a plunger and its vicinity of an electromagnetic valve according to a third embodiment of the present invention.

### DESCRIPTION OF EMBODIMENTS

### First Embodiment

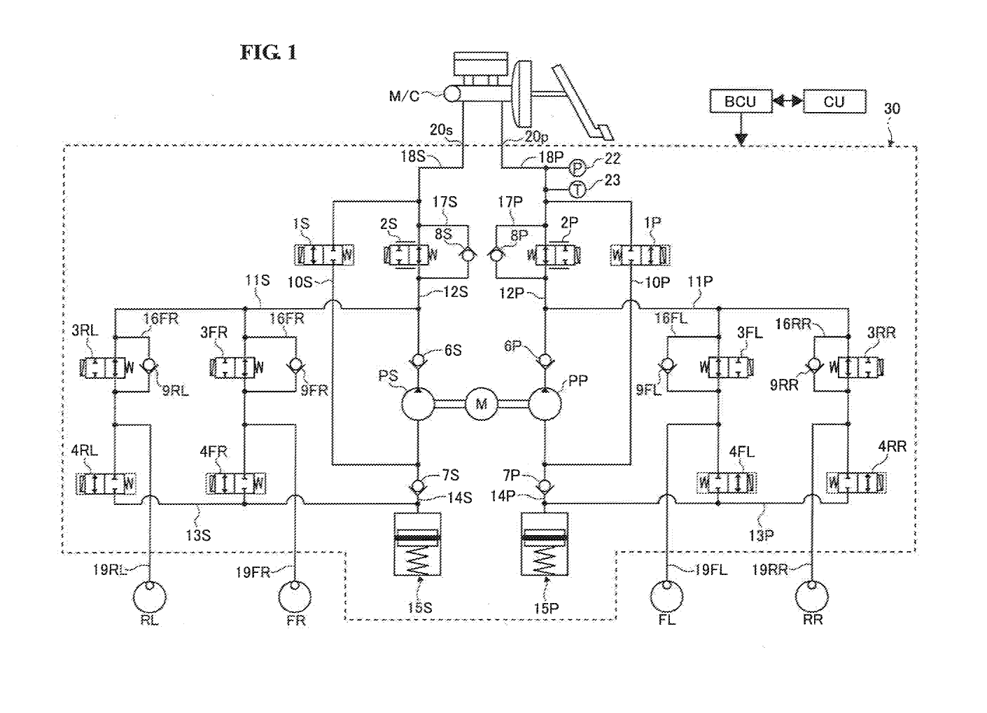

FIG. 1 is a hydraulic circuit diagram of a brake device according to a first embodiment of the present invention.

In the brake device, a hydraulic circuit system is provided in a hydraulic control unit 30 between a master cylinder M/C and wheel cylinders W/C such that the hydraulic control unit 30 performs hydraulic pressure control according to a hydraulic pressure demand for regenerative cooperation control of an integrated controller CU, which controls total vehicle driving conditions, as well as according to a hydraulic pressure demand for Vehicle Dynamics Control (VDC) or Anti-lock Brake System (ABS) of a brake controller BCU.

The hydraulic control unit 30 has a so-called X-type piping structure formed with two hydraulic circuits: a primary brake hydraulic circuit and a secondary brake hydraulic circuit. The front left wheel cylinder W/C(FL) and the rear right wheel cylinder WC(RR) are connected to the primary brake hydraulic circuit, whereas the front right wheel cylinder

W/C(FR) and the rear left wheel cylinder W/C(RL) are connected to the secondary brake hydraulic circuit. The hydraulic control unit 30 and the respective wheel cylinders W/C are connected to wheel cylinder ports 19 (19RL, 19FR, 19FL and 19RR) formed in an upper surface of a housing. Gear pumps PP and PS (sometimes generically referred to as “gear pumps P”) are provided to the primary and secondary brake hydraulic circuits, respectively, as a tandem gear pump unit and are each driven by a motor M.

The hydraulic control unit 30 and the master cylinder M/C are connected to hydraulic lines 18P and 18S through master cylinder ports 20P and 20S formed in a port connection surface of the housing. The hydraulic lines 18 are connected to the suction sides of the gear pumps P by hydraulic lines 10P and 10S. Gate-in valves 1P and 1S (sometimes generically referred to as “gate-in valves 1”), each of which is in the form of a normally closed type solenoid valve, are arranged on the hydraulic lines 10. A master cylinder pressure sensor 22 and a temperature sensor 23 are disposed on a part of the hydraulic line 18P between the master cylinder port 20P and the hydraulic line 10P. The wheel cylinders W/C are connected to the discharge sides of the gear pumps 1 by hydraulic lines 11P and 11S. Pressure boosting valves 3FL, 3RR, 3FR and 3RL (sometimes generically referred to as “pressure boosting valves 3”), each of which is in the form of a normally open type solenoid valve, are arranged on the hydraulic lines 11. Check valves 6P and 6S are arranged on parts of the hydraulic lines 11 between the pressure boosting valves 3 and the pump unit P. Each of the check valve 6 is configured to permit a flow of brake fluid in a direction from the gear pump P to the pressure boosting valves 3 but prevent a flow of brake fluid in an opposite direction.

Hydraulic lines 16FL, 16RR, 16FR and 16RL are provided to the respective hydraulic lines 11 so as to bypass the pressure boosting valves 3. Check valves 9FL, 9RR, 9FR and 9RL are arranged on the hydraulic lines 16. Each of the check valves 9 is configured to permit a flow of brake fluid in a direction from the wheel cylinder W/C to the master cylinder M/C but prevent a flow of brake fluid in an opposite direction. The master cylinder M/C is connected to the hydraulic lines 11 by hydraulic lines 12P and 12S. Herein, the junctions of the hydraulic lines 11 and the hydraulic lines 12 are located between the gear pumps P and the pressure boosting valves 3. Gate-out valves 2P and 2S (sometimes generically referred to as “gate-out valves 2”), each of which is in the form of a normally open type solenoid valve, are arranged on the hydraulic lines 12. Hydraulic lines 17P and 17S are provided to the respective hydraulic lines 12 so as to bypass the gate-out valves 2. Check valves 8S and SP are arranged on the hydraulic lines 12. Each of the check valves 8 is configured to permit a flow of brake fluid in a direction from the wheel cylinders W/C to the master cylinder M/C but prevent a flow of brake fluid in an opposite direction.

Reservoirs 15P and 15S are provided on the suction sides of the gear pumps P. The reservoirs 15 and the gear pumps P are connected to each other by hydraulic lines 14P and 14S. Check valves 7P and 7S (sometimes generically called “gate-out valves 2”) are arranged on between the reservoirs 15 and the gear pumps P. The wheel cylinders W/C are connected to the hydraulic lines 14 through hydraulic lines 13P and 13S. Herein, the junctions of the hydraulic lines 13 and the hydraulic lines 14 are located between the check valves 7 and the reservoirs 15. Pressure reducing valves 4FL, 4RR, 4FR and 4RL (sometimes generically referred to as “pressure reducing valves 4”), each of which is in the form of a normally closed type solenoid valve, are arranged on the hydraulic lines 13.

In the case where a boost of the hydraulic pressure is demanded for the wheel cylinder of any of wheels during VDC control, the hydraulic control unit opens the gate-in valve 1, closes the gate-out valve 2, opens the pressure boosting valve 3, closes the pressure reducing valve 4 and then drives the gear pump P so that the gear pump P sucks and discharges the brake fluid from the master cylinder WC to the wheel cylinder W/C through the gate-in valve 1 and thereby boost the hydraulic pressure of the wheel cylinder W/C for control of vehicle behavior. In the case where the hydraulic pressure demand is set for regenerative cooperation control of the integrated controller CU, the hydraulic control unit closes the pressure boosting valves 3 and opens the pressure reducing valves 4 for the wheel cylinders of the drive wheels and then drives the gear pumps P so that the gear pumps P recirculate the brake fluid from the reservoirs 15 to the master cylinder M/C. During the regenerative cooperation control, deterioration of pedal feeling can be avoided by balance control of the gate-out valves 2.

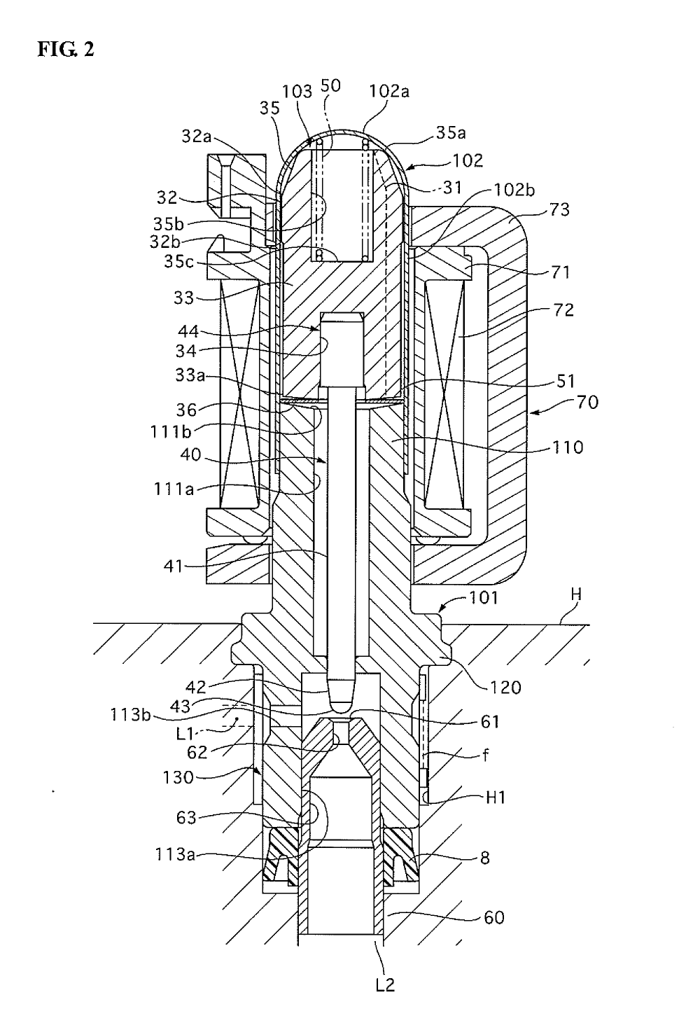

FIG. 2 is a section view of the gate-out valve as an electromagnetic valve according to the first embodiment.

In this electromagnetic valve, an inner body 101 is made of a magnetic material in a cylindrical shape. The inner body 101 has a first cylindrical portion 110 extending upwardly in FIG. 2 and adapted to serve as a magnetic path forming part, a swage portion 120 increased in diameter and fixed by swaging to the housing H and a second cylindrical portion 130 inserted in an electromagnetic valve insertion hole H1 of the housing H. A through hole 111a is formed through an inner periphery of the first cylindrical portion 110.

A through hole 113 a is formed through an inner periphery of the second cylindrical portion 130 with a diameter slightly larger than that of the through hole 11a. A concave inclined surface 111b is formed on an upper end of the first cylindrical portion 110 so as to be tapered in a conical shape toward the through hole 111a. A plurality of radial hydraulic passages 113b are formed in the second cylindrical portion 130 and is brought into communication with a first hydraulic passage L1 of the housing H.

A seat member 60 is press-fitted in the through hole 113a of the second cylindrical portion 130. The seat member 60 has a valve seat 61 formed in a concave bowl shape on an upper side thereof in FIG. 2 for contact with a front end portion of the after-mentioned plunger. A hydraulic passage 62 is formed axially through the center of the valve seat 61. A hydraulic passage 63 is formed in the seat member 61 with a diameter larger than that of the fluid passage 62 and is brought into communication with a second hydraulic passage L2 of the housing H.

filter f is attached to an outer periphery of the second cylindrical portion 113b so as to surround the radial hydraulic passages 113b and prevent contaminants etc. in the brake fluid from becoming adhered to the plunger 40 or the valve seat 61. A cup seal 8 is attached to an outer periphery of the seat member 60. In the first embodiment, the cup seal 8 performs the function of a check valve by sealing fluid leakage from the hydraulic passage L2 to the hydraulic passage L1 when the hydraulic pressure of the hydraulic passage L2 is higher than the hydraulic pressure of the hydraulic passage L1) and by permitting fluid leakage from the hydraulic passage L1 to the hydraulic passage L2 when the hydraulic pressure of the hydraulic passage L2 is lower than the hydraulic pressure of the hydraulic passage L1.

For use of this electromagnetic valve as the gate-out valve in the brake hydraulic control unit, the hydraulic passage L1 is connected to the master cylinder; and the hydraulic passage L2 is connected to the wheel cylinders. It is possible by such connection to, when the pressure of the master cylinder is set higher than the pressure of the wheel cylinders by driver's brake pedal depression, secure safety with the application of the hydraulic brake fluid pressure to the wheel cylinders even in a closed state of the gate-out valve.

A cylinder member 102 is fixed by welding to an upper side of the first cylindrical portion 110. The cylinder member 102 has a dome-shaped top wall portion 102a and a cylindrical portion 102b formed continuously from the top wall portion 102a. The cylindrical portion 102b is fitted on the first cylindrical portion 110 so as to surround an outer periphery of the first cylindrical portion 110 and is laser welded to the first cylindrical portion 110 throughout its entire circumference. Both of the cylinder member 102 and the first cylindrical portion 110 protrude from a surface of the housing H. A coil assembly 70 is arranged so as to cover the outer peripheries of the cylinder member 102 and the first cylindrical portion 110. The coil assembly 70 has a bobbin 71, a solenoid coil 72 wound around the bobbin 71 and a yoke 73 made of a magnetic material in a U-like cross-section shape so as to cover an outer periphery of the solenoid coil 72.

The inside of the cylinder member 102 is made hollow. A magnetic armature 103 is arranged in a hollow inner space of the cylinder member 102 so as to make a vertical stroke within the cylinder member 102. The armature 103 has a large-diameter portion 32 made large in diameter up to the same height position as an upper part of the yoke 73, an armature top portion 35 located above the upper part of the yoke 73 and tapered in shape from an upper end 32a of the large-diameter portion 32, a small-diameter portion 33 located below the upper part of the yoke 73 and formed continuously from a lower end 32b of the large-diameter portion 32 and a recess portion 34 formed substantially in the center of the small-diameter portion 33 from a lower end 33a of the small-diameter portion 33.

A substantially cylindrical spring installation part 35b is formed in a top end of the armature top portion 35. A coil spring 50 is set in a compressed state with a predetermined set load between a bottom 35c of the spring installation part 35b and an inner wall of the top wall portion 102a. In a de-energization state, a top end edge 35a of the armature top portion 35 is brought into contact with the inner wall of the top wall portion 102a. A disc spring contact surface 36 is formed in a convex shape on a part of the armature between the lower end 33a of the small-diameter portion 33 and the recess portion 34. Herein, the angle of inclination of the disc spring contact surface 36 is made smaller than that of the concave inclined surface 111b.

The disc spring contact surface 36 and the concave inclined surface 111b are in a convex-concave relationship. A disc spring 51 is set in a compressed state with a predetermined set load between the disc spring contact surface 36 and the concave inclined surface 111b. The disc spring 51 is elastically deformable within a clearance created between the disc spring contact surface 36 and the concave inclined surface 111b due to their different inclination angles. As long as the disc spring 51 is elastically deformable within such a clearance created due to the different inclination angles, the disc spring 51 can be in a tapered shape or a simple flat plate shape. In the case where the disc spring 51 is formed with a tapered surface, the inclination direction of the tapered surface can be adjusted as appropriate depending on the desired spring characteristics.

In the first embodiment, the condition: f1<f2 is satisfied where f1 is the set load of the coil spring 50; and f2 is the set load of the disc spring 51. Consequently, the plunger 40 and the armature 103 are biased upwardly by the action of a biasing force caused due to a difference between f1 and f2 in the de-energization state such that the front end portion 43 of the plunger 40 is kept separated from the valve seat 61 to establish communication between the first hydraulic passage L1 and the second hydraulic passage L2 are (as the normally open type valve).

It is possible to efficiently form a magnetic path by forming the large-diameter portion 32 up to substantially the same height as the yoke 73. It is also possible to avoid surface contact of the armature 103 with an inner periphery of the cylinder member 102 by forming the small-diameter portion 33. A groove 31 is axially formed in an outer periphery of the armature 103 so as to, when the armature 103 makes a stroke within the cylinder member 102, enable a smooth fluid flow and suppress fluid resistance during the stroke.

The plunger 40 is arranged inside the recess portion 34 of the armature 103 and the first cylindrical portion 110. The plunger 40 has, in addition to the front end portion 43, an engagement portion 44 combined with the armature 103 by engagement in the recess portion 34, a first shaft portion 41 made smaller in diameter than the engagement portion 44 and a second shaft portion 42 made smaller in diameter than the first shaft portion 41 3. The front end portion 43 is formed in a dome shape on a front end of the second shaft portion 42 and is brought into contact with or separated from the valve seat 61.

The opening/closing operations of the above-structured electromagnetic valve will be explained below.

When the solenoid coil 72 is energized with a predetermined current, the magnetic path is formed by the yoke 73, the armature 103 and the first cylindrical portion 110. There thus arises an attractive force between the lower end surface of the armature 103 and the upper end surface of the first cylindrical portion 110. The armature 103 is forced downwardly by the action of the attractive force. As the plunger 40 is moved downwardly by the armature 103, the front end portion 43 of the plunger 40 is brought into contact with the valve seat 61. The hydraulic passage 62 is totally closed when the front end portion 43 of the plunger 40 is brought into contact throughout its entire circumference with the valve seat 61. As a result, the first hydraulic passage L1 and the second hydraulic passage L2 are disconnected from each other. When the attractive force is proportionally controlled by PWM energization control of the coil assembly 70, the clearance between the front end portion 43 and the valve seat 61 (i.e. the cross-sectional area of the hydraulic passage) is adjusted to achieve a desired flow rate (hydraulic pressure).

Relationship of Disc Spring and Coil Spring

The reason for use of the disc spring will be next explained below.

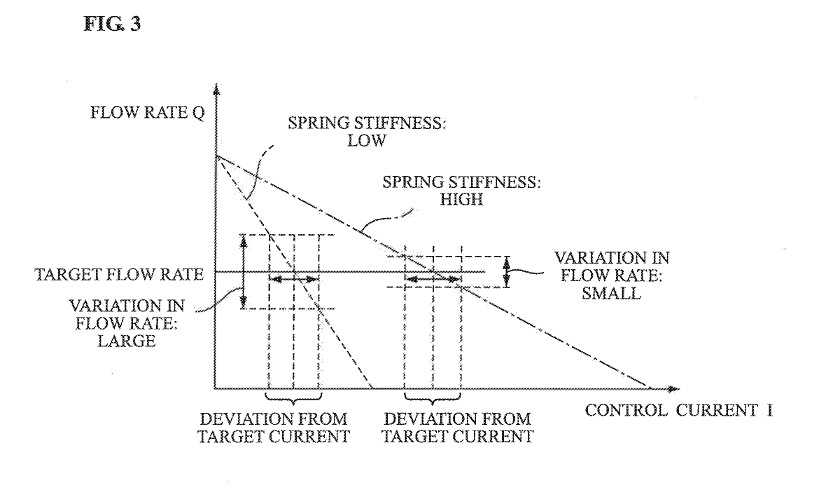

FIG. 3 is a characteristic diagram showing a relationship between the control current and flow rate of the electromagnetic valve in view of difference in spring stiffness.

The electromagnetic valve has a merit that the flow rate can be controlled by a small current in the case where the spring shows a large deformation relative to input force, i.e., low spring stiffness, such as the case of the coil spring. When the actual control current deviates from the target control current, however, there occurs a large change in the flow rate with respect to a deviation in the control current. The electromagnetic valve thus has a problem of a large variation in the flow rate with respect to a variation in the control current.

In the case the spring shows a small deformation relative to input force, i.e., high spring stiffness, such as the case of initial deformation or just before the maximum deflection point of the disc spring, on the other hand, there occurs a small change in the flow rate in response to a deviation between the actual control current and the target control current. The electromagnetic valve thus has a merit of a small variation in the flow rate with respect to a variation in the control current so that the the control accuracy can be improved. However, the electromagnetic valve has a problem that the flow rate has to be controlled by a large current due to its high spring stiffness.

Accordingly, the electromagnetic valve according to the first embodiment is so structured that: the load of the disc spring 51 acts on the plunger 40 in a valve opening direction; and the load of the coil spring 50 acts the plunger 40 in a valve closing direction. As the load of the disc spring 51 is set larger than the load of the coil spring 50, it is possible to not only maintain the valve open state during de-energization and initiate the valve closing operation even by energization with a small current but also improve the control accuracy by decrease of the change in the flow rate with respect to the change in the control current. These effects will be explained in more detail below with reference to comparative example.

Comparison of First Embodiment and Comparative Example

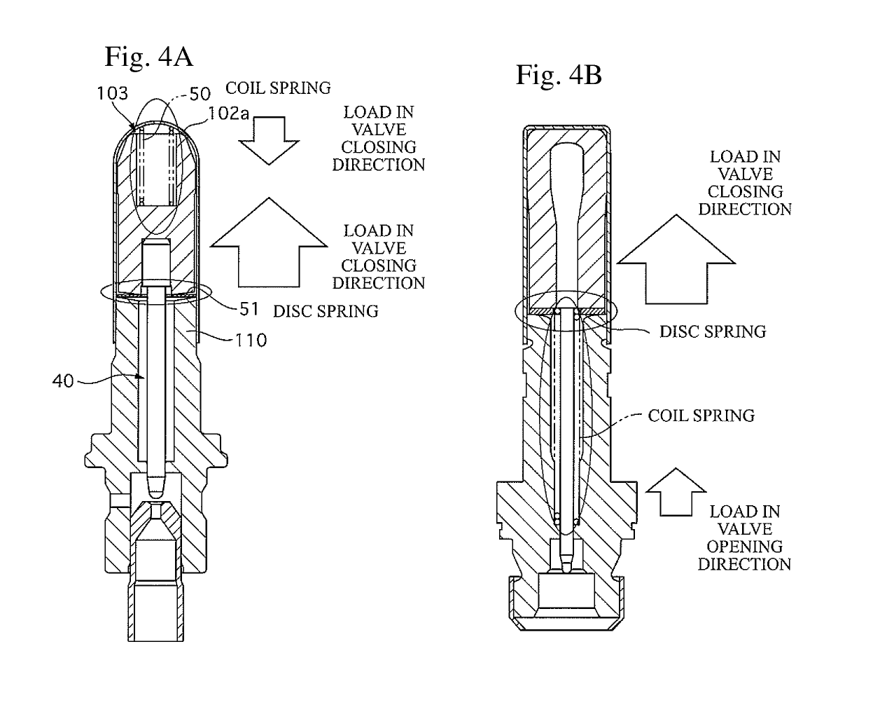

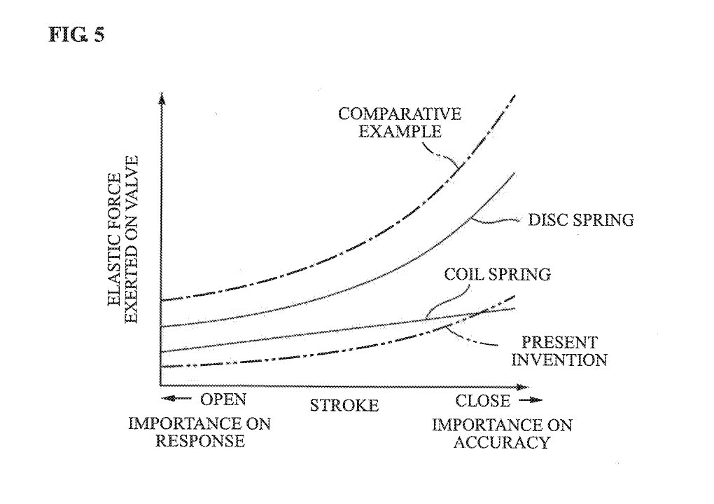

The valve characteristics achieved by the coil spring 50 and the disc spring 51 in the first embodiment will be explained below by way of comparison to the comparative example. FIG. 4 is a section view showing comparison between the first embodiment and the comparative example. FIG. 5 is a characteristic diagram showing a relationship of the plunger stroke and spring force of the electromagnetic valve according to the first embodiment and according to the comparative example. More specifically, FIG. 4(a) shows a cross section of the plunger 40 and its vicinity of the electromagnetic valve according to the first embodiment; and FIG. 4(b) shows a cross section of a plunger and its vicinity of the electromagnetic valve according to the comparative example. In the first embodiment, the load of the disc spring 51 acts on the plunger 40 in the valve opening direction; and the load of the coil spring 50 acts on the plunger 40 in the valve closing direction as mentioned above. The valve open state can be thus maintained during de-energization. In the comparative example, by contrast, both of a load of the disc spring and a load of the coil spring act on the plunger 40 in a valve opening direction as shown in FIG. 4(b).

FIG. 5 shows the characteristics of the electromagnetic valves according to the first embodiment and according to the comparative example in the case where the elastic moduli of the disc spring and the coil spring in the first embodiment are set to the same those in the comparative example. In FIG. 5, thin solid lines indicate a relationship between the elastic force and stroke amount of the disc spring and a relationship between the elastic force and stroke amount of the coil spring; one-dot chain line indicates a relationship between the total spring elastic force and stroke amount in the comparative example; and two-dot chain line indicates a relationship between the total spring elastic force and stroke amount in the first embodiment. The coil spring has the elastic property that the elastic force linearly increases with respect to increase in the stroke amount, whereas the disc spring has the elastic property that the rate of increase in the elastic force with respect to increase in the stroke amount is small in the initial stage of valve closing from the valve open state and becomes higher with the progress of valve closing.

In the comparative example, the elastic property of the coil spring is added to the elastic property of the disc spring so that the elastic force exerted on the plunger is large at the time of valve opening and becomes significantly increased with the progress of valve closing. This results in high power consumption and leads to increase of coil size.

In the first embodiment, by contrast, the elastic property of the coil spring is subtracted from the elastic property of the disc spring so that the elastic force exerted on the plunger is small at the time of valve opening and can be limited to a sufficiently small value than that of the comparative example during the progress of valve closing because of the reason that the elastic force of the coil spring increases as the elastic force of the disc spring increases with the progress of valve closing.

In general, importance is put on the control response when the valve closing operation is initiated from the valve open state; and, as coming closer to the valve close state, importance is put on the control accuracy in view of the fact that the flow rate is influenced even by a slight change in valve opening amount. In the first embodiment, the degree of change in the elastic force relative to the stroke amount becomes small in the vicinity of the valve open state by the use of the elastic property of the disc spring. As the flow rate can be largely changed with a small change in the control current, it is possible to secure the control response of the flow rate. In the vicinity of the valve close state, on the other hand, the degree of change in the elastic force relative to the stroke amount becomes large in the first embodiment. As the flow rate cannot be largely changed unless with a large current, it is less likely to occur a variation in the flow rate with respect to a variation in the control current and is thereby possible to improve the control accuracy of the flow rate.

As described above, the operations and effects of the first embodiment are as follows.

(1-1) The electromagnetic valve is characterized by comprising:

the wound coil assembly 70 with the bobbin 71, the solenoid coil 72 and the yoke 73 (as a solenoid);

the cylinder member 102 (as a cylindrical member) arranged in an inner periphery of the solenoid and formed of a non-magnetic material;

the armature 103 (as a magnetic member) being axially movable within the cylinder member 102 by the action of an electromagnetic force generated upon energization of the coil 72;

the inner body 101 (as a body) arranged adjacent to one end portion of the armature 103 and formed of a magnetic material with a hollow part;

the plunger 40 (as a valve element) arranged in the hollow part and being axially movable by axial movement of the armature 103;

the seat member 60 having the hydraulic passage formed therein such that the hydraulic passage can be closed by contact with the plunger 40;

the disc spring 51 (as a first elastic member) that biases the plunger 40 in the valve opening direction; and

the coil spring 50 (as a second elastic member) that biases the armature 103 in the direction that counteracts the biasing of the disc spring 51,

the disc spring 51 being set with a set load larger than that of the coil spring 50.

It is possible in this configuration to attain low current consumption by taking advantage of the property of the disc spring 51 as the first elastic member and decreasing the elastic force exerted on the valve element with the use of the coil spring 50 as the second elastic member.

(1-2) The electromagnetic valve of the above configuration (1-1) is further characterized in that the coil spring 50 is set in a compressed state between the cylinder member 102 and the armature 103.

It is possible in this configuration to allow easy installation of the coil spring 50 at the time of inserting the armature 103 into the cylinder member 102.

(1-3) The electromagnetic valve of the above configuration (1-1) is further characterized in that the coil spring 50 is set in a compressed state between the spring installation part 35b (of the other end portion) of the armature 103 and the cylinder member 102.

It is possible in this configuration to allow easy installation of the coil spring 50 at the time of inserting the armature 103 into the cylinder member 102.

(1-4) The electromagnetic valve of the above configuration (1-3) is further characterized in that the spring installation part 35b (as a recess part) is formed in the other end portion of the armature 103 so as to install therein the coil spring 50.

It is possible in this configuration to allow a reduction in axial dimension by partial installation of the coil spring 50 in the spring installation part 35b.

(1-5) The electromagnetic valve of the above configuration (1-1) is further characterized in that: the armature 103 and the plunger 104 are combined with each other; and the disc spring 51 is set in a compressed state between the inner body 101 and a surface of the one end portion of the armature 103.

It is possible in this configuration to allow arrangement of the disc spring 51 by simple operation of inserting the armature 103 and the plunger 104 into the cylinder member 102, inserting the disc spring 51 and then fixing the inner body 101.

(1-6) The electromagnetic valve of the above configuration (1-5) is further characterized in that the disc spring 51 is disc-shaped.

It is possible in this configuration to allow a reduction in axial dimension as compared to the case of using a coil spring.

(1-7) The electromagnetic valve of the above configuration (1-6) is further characterized in that: the inner body 101 has the concave inclined surface 111b (as an inclined surface) facing the surface of the one end portion of the armature 103 such that the surface of the one end portion of the armature 103 and the inclined surface 111b of the inner body 101 are in a convex-concave relationship; and the disc spring 51 is set in a compressed state with an outer periphery of the disc spring 51 being in contact with the inner body 101 and an inner periphery of the disc spring 51 being in contact with the armature 103.

It is possible in this configuration to ensure the attractive area between the armature 103 and the inner body 101 for improvement of controllability and, at the same time, allow easy arrangement of the disc spring 51.

(1-8) The electromagnetic valve is characterized by comprising:

the wound coil assembly 70 with the bobbin 71, the solenoid coil 72 and the yoke 73 (as a solenoid);

the cylinder member 102 (as a cylindrical member) arranged in an inner periphery of the solenoid and formed of a non-magnetic material;

the armature 103 (as a magnetic member) being axially movable within the cylinder member 102 by the action of an electromagnetic force generated upon energization of the coil 72;

the inner body 101 (as a body) arranged adjacent to one end portion of the armature 103 and formed of a magnetic material with a hollow part;

the plunger 40 (as a valve element) arranged in the hollow part and being axially movable by axial movement of the armature 103;

the seat member 60 having the hydraulic passage formed therein such that the hydraulic passage can be closed by contact with the plunger 40;

the coil spring 50 (as an elastic member) arranged adjacent to the other end portion of the armature 103 and set to bias the armature 103 toward the inner body 101; and

the disc spring 51 (as a disc member) arranged elastically deformably between the one end portion of the armature 103 and the inner body 101 and set with a set load larger than that of the coil spring 50.

It is possible in this configuration to attain low current consumption by taking advantage of the property of the disc spring 51 as the disc member and decreasing the elastic force exerted on the valve element with the use of the coil spring 50 as the elastic member.

(1-9) The electromagnetic valve of the above configuration (1-8) is further characterized in that the coil spring 50 is set in a compressed state between the cylinder member 102 and the armature 103.

It is possible in this configuration to allow easy installation of the coil spring 50 at the time of inserting the armature 103 into the cylinder member 102.

(1-10) The electromagnetic valve of the above configuration (1-8) is further characterized in that the spring installation part 35b (as a recess part) is formed in the other end portion of the armature 103 so as to install therein the coil spring 50.

It is possible in this configuration to allow a reduction in axial dimension by partial installation of the coil spring 50 in the spring installation part 35b.

(1-11) The electromagnetic valve of the above configuration (1-10) is further characterized in that: the cylinder member 102 is cup-shaped; and the coil spring 50 is used as the elastic member having one end held at the bottom of the cylinder member 102 (cup-shaped member) and the other end held at the bottom 35c of the spring installation part 35b.

It is possible in this configuration to allow a reduction in axial dimension by partial installation of the coil spring 50 in the spring installation part 35b.

(1-12) The electromagnetic valve of the above configuration (1-8) is further characterized in that the disc spring 51 is disc-shaped.

It is possible in this configuration to allow a reduction in axial dimension as compared to the case of using a coil spring.

(1-13) The electromagnetic valve of the above configuration (1-8) is further characterized in that: the inner body 101 has the concave inclined surface 111b (as an inclined surface) facing a surface of the one end portion of the armature 103 such that the surface of the one end portion of the armature 103 and the inclined surface 111b of the inner body 101 are in a concave-convex relationship; and the disc spring 51 is set in a compressed state with an outer periphery of the disc spring 51 being in contact with the inner body 101 and an inner periphery of the disc spring 51 being in contact with the armature 103.

It is possible in this configuration to ensure the attractive area between the armature 103 and the inner body 101 for improvement of controllability and, at the same time, allow easy arrangement of the disc spring 51.

(1-14) The brake device comprises: the master cylinder M/C or the pump P (as a hydraulic pressure source) adapted to control the hydraulic pressure of the wheel cylinder W/C; and the gate-out valve 2, characterized in that:

the gate-out valve 2 comprises:

the wound coil assembly 70 with the bobbin 71, the solenoid coil 72 and the yoke 73 (as a solenoid);

the cylinder member 102 (as a cylindrical member) arranged in an inner periphery of the solenoid and formed of a non-magnetic material;

the armature 103 (as a magnetic member) being axially movable within the cylinder member 102 by the action of an electromagnetic force generated upon energization of the coil 72;

the inner body 101 (as a body) arranged adjacent to one end portion of the armature 103 and formed of a magnetic material with a hollow part;

the plunger 40 (as a valve element) arranged in the hollow part and being axially movable by axial movement of the armature 103;

the seat member 60 having the hydraulic passage formed therein such that the hydraulic passage can be closed by contact with the plunger 40;

the disc spring 51 (as a first elastic member) that biases the plunger 40 in the valve opening direction; and

the coil spring 50 (as a second elastic member) that biases the armature 103 in the direction that counteracts the biasing of the disc spring 51,

the disc spring 51 being set with a set load larger than that of the coil spring 50.

It is possible in this configuration to attain low current consumption by taking advantage of the property of the disc spring 51 as the first elastic member and decreasing the elastic force exerted on the valve element with the use of the coil spring 50 as the second elastic member.

(1-15) The brake device of the above configuration (1-14) is further characterized in that the disc spring 51 is disc-shaped.

It is possible in this configuration to allow a reduction in axial dimension as compared to the case of using a coil spring.

(1-16) The brake device of the above configuration (1-15) is further characterized in that the inner body 101 has the concave inclined surface 111b (as an inclined surface) facing a surface of the one end portion of the armature 103 such that the surface of the one end portion of the armature 103 and the inclined surface 111b of the inner body 101 are in a concave-convex relationship.

It is possible in this configuration to ensure the attractive area between the armature 103 and the inner body 101 for improvement of controllability.

(1-17) The brake device of the above configuration (1-15) is further characterized in that the disc spring 51 (disc member) is flat plate-shaped.

It is possible in this configuration to allow a reduction in axial dimension as compared to the case of using a coil spring.

(1-18) The brake device of the above configuration (1-17) is further characterized in that the disc spring 51 is set in a compressed state with an outer periphery of the disc spring 51 being in contact with the inner body 101 and an inner periphery of the disc spring 51 being in contact with the armature 103.

It is possible in this configuration to allow easy arrangement of the disc spring 51.

(1-19) The brake device of the above configuration (1-14) is further characterized in that the gate-out valve 2 adjusts the position of the valve element by energization of the solenoid coil 72 with a current according to a pressure difference between high hydraulic brake fluid pressure upstream of the plunger 40 and low hydraulic brake fluid pressure downstream of the plunger 40.

It is possible in this configuration to stabilize the relationship between the stroke of the plunger 40 and the energization current for improvement of controllability.

(1-20) The brake device of the above configuration (1-14) is further characterized in that the gate-out valve is arranged such that the high hydraulic brake fluid pressure is exerted on the plunger 40 in the valve opening direction.

It is possible in this configuration to stabilize the relationship between the plunger stroke and the energization current for improvement of controllability without the valve opening operation being interfered with by the pressure difference.

### Second Embodiment

Next, a second embodiment of the present invention will be explained below. The second embodiment is basically the same in structure to the first embodiment. The following explanation will be given to differences of the second embodiment from the first embodiment.

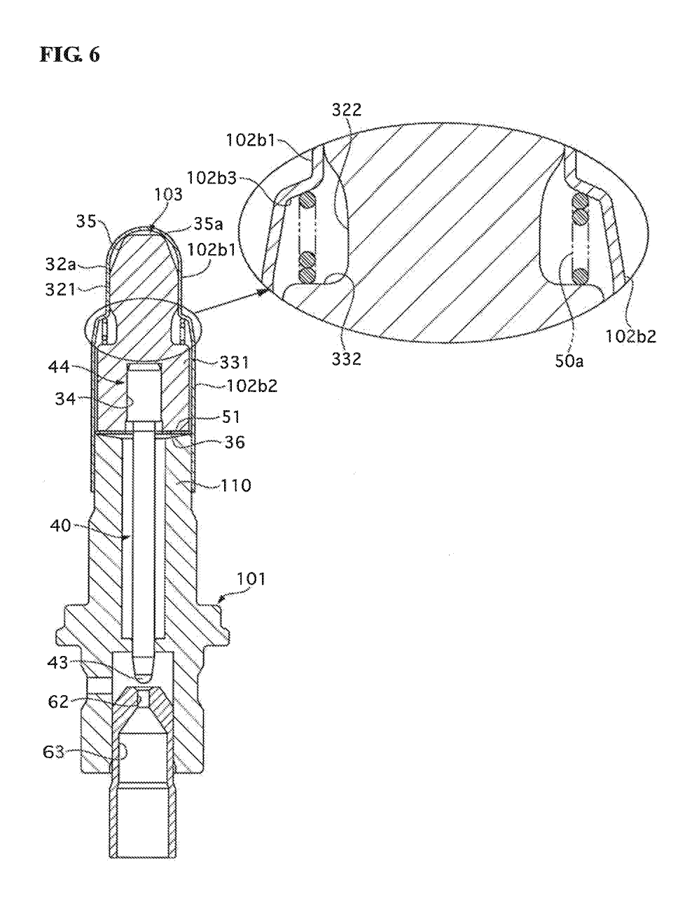

FIG. 6 is a section view of a plunger and its vicinity of an electromagnetic valve according to the second embodiment. In the first embodiment, the spring installation part 35b is formed in the top wall portion 102a of the armature 103. In the second embodiment, on the other hand, a coil spring 50a is held at a lateral surface of a middle part of the armature 103.

More specifically, in the second embodiment, the armature 103 has a small-diameter portion 321, a constricted portion 322 made smaller in diameter than the small-diameter portion 321, a large-diameter portion 331 connected to the constricted portion 322 and made larger in diameter than the small-diameter portion 321 and a stepped portion 332 formed at a connection region between the constricted portion 322 and the large-diameter portion 331. Further, the cylinder member 102 has a small-diameter cylindrical portion 102b1 in which the small-diameter portion 321 makes a stroke, a large-diameter cylindrical portion 102b2 in which the large-diameter portion 331 makes a stroke and a constricted portion 102b3 connecting the small-diameter cylindrical portion 102b1 and the large-diameter cylindrical portion 102b2 to each other. The constricted portion 102b3 is arranged to overlap the stepped portion 332 when viewed in the axial direction. The coil spring 50a is set in a compressed state between the stepped portion 332 and the constricted portion 102b3. It is thus possible to obtain the same effects as in the first embodiment.

### Third Embodiment

A third embodiment of the present invention will be next explained below. The third embodiment is basically the same in structure to the first embodiment. The following explanation will be given to differences of the third embodiment from the first embodiment.

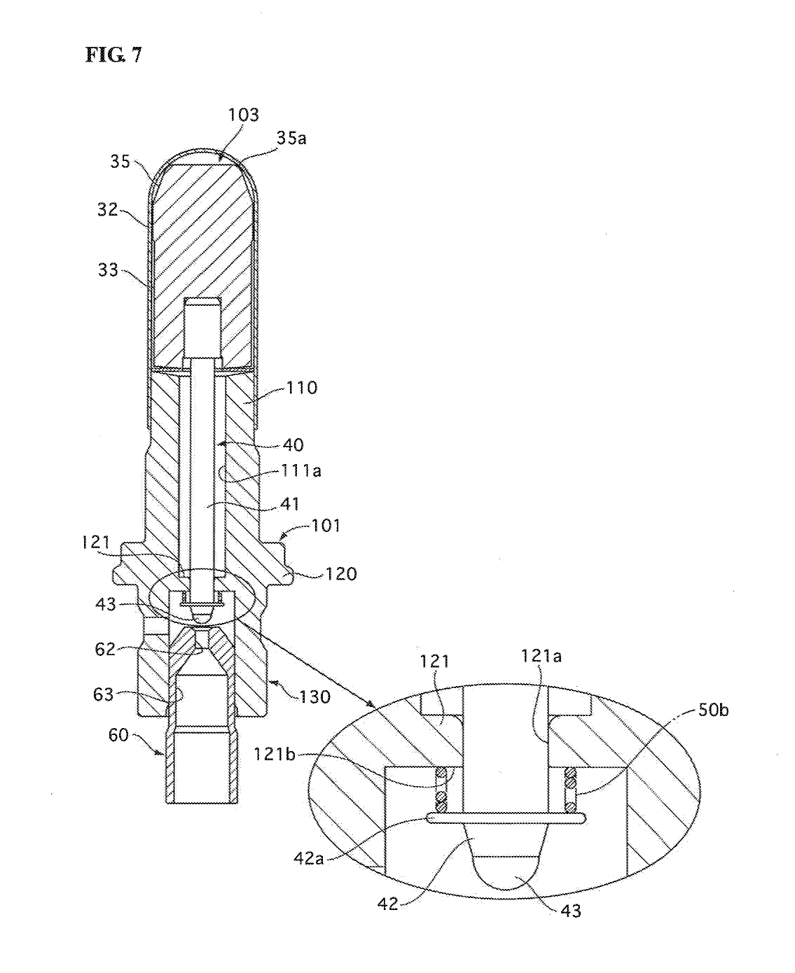

FIG. 7 is a section view of a plunger and its vicinity of an electromagnetic valve according to the third embodiment. In the first embodiment, the spring installation part 35b is formed in the top wall portion 102a of the armature 103. In the third embodiment, on the other hand, a coil spring 50b is held at a front end part of the armature 103.

More specifically, in the third embodiment, the inner body 101 has a diameter-reduced stepped portion 121 formed below the through hole 111a so as to allow passage of the first shaft portion 41 of the plunger 40 therethrough and retain the plunger 40. A through hole 121 a is formed in the center of the diameter-reduced stepped portion 121. A retaining surface 121b is formed on a surface of the diameter-reduced stepped portion 121 facing the seat member 60.

Further, an annular plate-shaped spring retaining part 42a is formed, at a position between the first shaft portion 41 and the second shaft portion 42 in the vicinity of the front end of the plunger 40, with a diameter larger than that of the first shaft portion 41. The retaining surface 121b is arranged to overlap the spring retaining part 42a when viewed in the axial direction of the plunger 40. The coil spring 50b is set in a compressed state between the retaining surface 121b and the spring retaining part 42a so that the elastic force of the coil spring 50b acts in the valve closing direction. It is thus possible to obtain the same effects as in the first embodiment.

The present invention has been described with reference to, but is not limited to, the above specific embodiments. Various modifications and variations of the embodiments are possible within the scope of the present invention.

It is feasible to provide the disc spring in any shape capable of showing a desired elastic modulus although the disc spring is annular flat plate-shaped in the above embodiments. For example, the disc spring may alternatively be formed with a varying thickness or formed with an inclination.

It is feasible to provide any elastic member other than the coil spring (such as a rubber or resin member) although the coil spring is provided in the above embodiments. For example, a disc spring is provided in place of the coil spring as the second elastic member such that the disc springs are arranged in series and set to satisfy the relationship of biasing load as the first and second elastic members.

Although the electromagnetic valve is used as the gate-out valve of the brake device in the above embodiments, it is feasible to adopt the electromagnetic valve as any normally open type valve where proportional control is required such as a pressure boosting/regulating valve of a brake-by-wire system.

### DESCRIPTION OF REFERENCE NUMERALS

1: Gate-in valve

2: Gate-out valve

3: Pressure boosting valve

4: Pressure reducing valve

15: Reservoir

19: Wheel cylinder port

20: Master cylinder port

30: Hydraulic control unit

32: Large-diameter portion

33: Small-diameter portion

34: Recess portion

35: Armature top portion

35a: Top end edge

35b: Spring installation part

35c: Bottom

36: Disc spring contact surface

40: Plunger

42a: Spring retaining part

43: Front end portion

50: Coil spring

50a: Coil spring

50b: Coil spring

51: Disc spring

60: Seat member

61: Valve seat

70: Coil assembly

71: Bobbin

72: Solenoid coil

73: Yoke

101: Inner body

102: Cylinder member

103: Armature

110: First cylindrical portion

111a: Through hole

111b: Concave inclined surface

121: Diameter-reduced stepped portion

121a: Through hole

121b: Retaining surface

130: Second cylindrical portion

M: Motor

M/C: Master cylinder

P: Gear pump

W/C: Wheel cylinder

1. An electromagnetic valve, comprising:
a solenoid having a wound coil;
a cylindrical member arranged in an inner periphery of the solenoid and formed of a non-magnetic material;
a magnetic member being axially movable within the cylindrical member by the action of an electromagnetic force generated upon energization of the coil;
a body arranged adjacent to one end portion of the magnetic member and formed of a magnetic material with a hollow part;
a valve element arranged in the hollow part and being axially movable by axial movement of the magnetic member;
a seat member having a hydraulic passage formed therein such that the hydraulic passage can be closed by contact with the valve element;
a first elastic member that biases the valve element in a valve opening direction; and
a second elastic member that biases the magnetic member in a direction that counteracts the biasing of the first elastic member,
the first elastic member being set with a set load larger than that of the second elastic member.

2. The electromagnetic valve according to claim 1,
wherein the second elastic member is set in a compressed state between the cylindrical member and the magnetic member.

3. The electromagnetic valve according to claim 1,
wherein the second elastic member is set in a compressed state between the cylindrical member and the other end portion of the magnetic member.

4. The electromagnetic valve according to claim 3,
wherein a recess part is formed in the other end portion of the magnetic member so as to install therein the second elastic member.

5. The electromagnetic valve according to claim 1,
wherein the magnetic member and the valve element are combined with each other; and
wherein the first elastic member is set in a compressed state between the body and the one end portion of the magnetic member.

6. The electromagnetic valve according to claim 5,
wherein the first elastic member is a disc member.

7. The electromagnetic valve according to claim 6,
wherein the body has an inclined surface facing a surface of the one end portion of the magnetic member such that the surface of the one end portion of the magnetic member and the inclined surface of the body are in a convex-concave relationship; and
wherein the disc member is set in a compressed state with an outer periphery of the disc member being in contact with the body and an inner periphery of the disc member being in contact with the magnetic member.

8. An electromagnetic valve, comprising:
a solenoid having a wound coil;
a cylindrical member arranged in an inner periphery of the solenoid and formed of a non-magnetic material;
a magnetic member being axially movable within the cylindrical member by the action of an electromagnetic force generated upon energization of the coil;
a hollow body arranged adjacent to one end portion of the magnetic member and formed of a magnetic material with a hollow part;
a valve element arranged in a hollow space of the body and being axially movable by axial movement of the magnetic member;
a seat member having a hydraulic passage formed therein such that the hydraulic passage can be closed by contact with the valve element;
an elastic member arranged adjacent to the other end portion of the magnetic member and set to bias the magnetic member toward the body; and
a disc member arranged elastically deformably between the one end portion of the magnetic member and the body and set with a set load larger than that of the elastic member.

9. The electromagnetic valve according to claim 8,
wherein the elastic member is set in a compressed state between the cylindrical member and the other end portion of the magnetic member.

10. The electromagnetic valve according to claim 8,
wherein a recess part is formed in the other end portion of the magnetic member so as to install therein the elastic member.

11. The electromagnetic valve according to claim 10,
wherein the cylindrical member is cup-shaped; and
wherein the elastic member is a coil spring having one end held at a bottom of the cylindrical member and the other end held at a bottom of the recess part.

12. The electromagnetic valve according to claim 8,
wherein the disc member is flat plate-shaped.

13. The electromagnetic valve according to claim 8,
wherein the body has an inclined surface facing a surface of the one end portion of the magnetic member such that the surface of the one end portion of the magnetic member and the inclined surface of the body are in a convex-concave relationship; and
wherein the disc member is set in a compressed state with an outer periphery of the disc member being in contact with the body and an inner periphery of the disc member being in contact with the magnetic member.

14. A brake device, comprising: a hydraulic pressure source adapted to control a hydraulic pressure of a wheel cylinder; and an electromagnetic valve,
the electromagnetic valve comprising:
a solenoid having a wound coil;
a cylindrical member arranged in an inner periphery of the solenoid and formed of a non-magnetic material with one end thereof closed;
a magnetic member being axially movable within the cylindrical member by the action of an electromagnetic force generated upon energization of the coil;
a body integrally fixed to the other open end portion of the cylindrical member and formed of a magnetic material with a hollow part;
a valve element arranged in the hollow part and being axially movable by axial movement of the magnetic member;
a seat member having a hydraulic passage formed therein such that the hydraulic passage can be closed by contact with the valve element;
a first elastic member arranged to bias the valve element in a direction that separates the valve element from the seat member; and
a second elastic member arranged between the magnetic member and the closed end portion of the cylindrical member to bias the magnetic member toward the body,
the first elastic member being set with a set load larger than that of the second elastic member.

15. The brake device according to claim 14,
wherein the first elastic member is a disc member.

16. The brake device according to claim 15,
wherein the body has an inclined surface facing a surface of one end portion of the magnetic member such that the surface of the one end portion of the magnetic member and the inclined surface of the body are in a concave-convex relationship.

17. The brake device according to claim 15,
wherein the disc member is flat plate-shaped.

18. The brake device according to claim 17,
wherein the disc member is set in a compressed state with an outer periphery of the disc member being in contact with the body and an inner periphery of the disc member being in contact with the magnetic member.

19. The brake device according to claim 14,
wherein the electromagnetic valve adjusts the position of the valve element by energization of the solenoid with a current according to a pressure difference between high hydraulic brake fluid pressure upstream of the valve element and low hydraulic brake fluid pressure downstream of the valve element.

20. The brake device according to claim 19,
wherein the electromagnetic valve is arranged such that the high hydraulic brake fluid pressure is exerted on the valve element in a valve opening direction.
